(19) United States
(12) Patent Application Publication
(10) Pub. No.: US 2019/0236579 A1
(43) Pub. Date: Aug. 1, 2019

(54) SYSTEM AND METHOD FOR DOCUMENT-INTEGRATED INTERACTIONS

(71) Applicant: Adam Grant Miller, Fort Worth, TX (US)

(72) Inventor: Adam Grant Miller, Fort Worth, TX (US)

(21) Appl. No.: 15/881,780

(22) Filed: Jan. 28, 2018

(51) Int. Cl. G06Q 20/32; G06Q 20/02; G06F 3/0484; G06F 17/30; G06Q 10/10

(52) U.S. Cl. CPC G06Q 20/325; G06Q 20/02; G06Q 10/10; G06F 17/30165; G06F 3/0484

(57) ABSTRACT

Embodiments described herein provide for a system and method for document sharing across a provider-client communicable network. The system facilitates both the interaction between the provider and client as well as the exchange of provider-associated documents.

### FIELD

The present invention generally relates to a system and method for file sharing across a network wherein client to provider interactions are performed.

### BACKGROUND

With the increasing prevalence of the internet and usage of networks connecting people all over the world, new means of customer service and data sharing are now possible. Still today, many industries rely on face-to-face interactions between service providers and their clients. These industries commonly include insurance, legal, healthcare, and similar service providers wherein a high volume of documents may be executed and exchanged.

While industries and their consumers prefer a face-to-face interaction, a growing number of individuals prefer to go through the process via an online format. Although video calls are now commonplace, they do not provide a full suite of features to suit the client-consumer relationship typical in today's world.

Platforms have been developed to facilitate file sharing, especially those across a professional workplace such as a law firm, or insurance office. Previously, these process required immense amounts of paper each needed stringent organization to ensure the proper documents are sent to the correct person at a proper time.

From a providers perspective, a higher level of communication is required to maintain client satisfaction, increase convenience, and enhance the customer relationship. These all work in unison to support the core business processes.

In light of current technologies and their applications to client-provider interactions, it can be seen that an advance in the arts surrounding document sharing for a variety of businesses is warranted. The invention should facilitate the provider-client interaction by increasing fidelity, and fostering secure document exchange throughout the system. One such advancement is described in various embodiments herein.

### SUMMARY OF THE INVENTION

Embodiments described herein provide for a system and method related to client-provider interactions wherein documents are exchanged. The system operated to further convenience the client and provider experience by utilizing remote connectivity to facilitate the interaction. Meanwhile, rather than sending and receiving hard copies of documents, these same documents may be electronically transmitted to facilitate a user-friendly experience. According to one embodiment, the system comprise sa network having a wireless communication interface configured to connect to client devices and a client-associated device having a processor in communication with a user interface. The interface is operable to perform a variety of processes including; determining provider availability, executing a payment any one of the plurality of providers, engaging in a provider-client interaction, and exchanging one or more actions with any one of the plurality of providers. Further, the embodiment may provide for a provider-associated device having a processor in communication with a user interface. The user interface is operable to; display previous client interactions, engage in a provider-client interaction, upload and send a plurality of documents, and request and receive payments from any number of clients.

In an embodiment, an adaptive transmission controller processes content in multiple mobile versions optimized to screen sizes of the client devices. This permits a plurality of PED devices to be used without sacrificing functionalities of the system.

In another embodiment, any number of external devices may be utilized, such as a scanner, in order to properly execute documents.

Availability of the each of the plurality of providers is determined by the processor operable in executing a variety of steps including determining current login status of each of the plurality of providers to the user interface, determining current interaction activity of the provider, and initiating an available indicator.

A method of storing data related to a client to provider interaction may comprise a plurality of steps including; the client initiating a document-integrated interaction system, the client initiating an interaction subsystem, receiving interaction from at least one provider, receiving at least one action request from the at least one provider, executing the at least one action request, uploading the executed action to the at least one provider, and storing the executed action request in a database.

In yet another embodiment, a method of providing services to a remote client over a network may comprise a plurality of steps including, establishing an interaction between a client and at least one provider providing a service. Next, data is stored remotely from the client. The client is permitted to select a service from the provider while the provide may request payment therefrom dependent upon the selected service or services. An action may then be directed from a provide to the client device whereon it may be executed by the client. The executed action may be redirected to the provider and stored within the network database or similar implement.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of the document sharing system, according to an embodiment of the present invention;

FIG. 2 illustrates a block diagram of a storage procedure, according to an embodiment of the present invention;

FIG. 3 illustrates a schematic representation of a screenshot of the mobile device associated user interface, according to an embodiment of the present invention;

FIG. 4 illustrates a schematic representation of a screenshot of the mobile device associated user interface, according to an embodiment of the present invention;

FIG. 5 illustrates a schematic representation of a screenshot of the mobile device associated user interface, according to an embodiment of the present invention;

FIG. 6 illustrates a schematic representation of a screenshot of the mobile device associated user interface, according to an embodiment of the present invention;

FIG. 7 illustrates a schematic representation of a screenshot of the mobile device associated user interface, according to an embodiment of the present invention;

FIG. 8 illustrates a schematic representation of a screenshot of the mobile device associated user interface, according to an embodiment of the present invention;

FIG. 9 illustrates a schematic representation of a screenshot of the mobile device associated user interface, according to an embodiment of the present invention;

FIG. 10 illustrates a schematic representation of a screenshot of the mobile device associated user interface, according to an embodiment of the present invention;

FIG. 11 illustrates a schematic representation of a screenshot of the mobile device associated user interface, according to an embodiment of the present invention;

FIG. 12 illustrates a schematic representation of a screenshot of the mobile device associated user interface, according to an embodiment of the present invention;

FIG. 13 illustrates a schematic representation of a screenshot of the mobile device associated user interface, according to an embodiment of the present invention;

FIG. 14 illustrates a schematic representation of a screenshot of the mobile device associated user interface, according to an embodiment of the present invention;

FIG. 15 illustrates a schematic representation of a screenshot of the mobile device associated user interface, according to an embodiment of the present invention;

FIG. 16 illustrates a schematic representation of a screenshot of the mobile device associated user interface, according to an embodiment of the present invention;

FIG. 17 illustrates a schematic representation of a screenshot of the mobile device associated user interface, according to an embodiment of the present invention;

FIG. 18 illustrates a schematic representation of a screenshot of the mobile device associated user interface, according to an embodiment of the present invention;

FIG. 19 illustrates a schematic representation of a screenshot of the user interface, according to an embodiment of the present invention;

FIG. 20 illustrates a schematic representation of a screenshot of the user interface, according to an embodiment of the present invention;

FIG. 21 illustrates a schematic representation of a screenshot of the user interface, according to an embodiment of the present invention;

FIG. 22 illustrates a schematic representation of a screenshot of the user interface, according to an embodiment of the present invention;

FIG. 23 illustrates a schematic representation of a screenshot of the user interface, according to an embodiment of the present invention;

FIG. 24 illustrates a schematic representation of a screenshot of the user interface, according to an embodiment of the present invention;

FIG. 25 illustrates a schematic representation of a screenshot of the user interface, according to an embodiment of the present invention;

FIG. 26 illustrates a schematic representation of a screenshot of the user interface, according to an embodiment of the present invention;

FIG. 27 illustrates a schematic representation of a screenshot of the user interface, according to an embodiment of the present invention;

FIG. 28 illustrates a schematic representation of a screenshot of the user interface, according to an embodiment of the present invention;

FIG. 29 illustrates a schematic representation of a screenshot of the user interface, according to an embodiment of the present invention;

FIG. 30 illustrates a schematic representation of a screenshot of the user interface, according to an embodiment of the present invention;

FIG. 31 illustrates a schematic representation of a screenshot of the user interface, according to an embodiment of the present invention;

FIG. 32 illustrates a schematic representation of a screenshot of the user interface, according to an embodiment of the present invention;

FIG. 33 illustrates a schematic representation of a screenshot of the user interface, according to an embodiment of the present invention;

FIG. 34 illustrates a schematic representation of a screenshot of the user interface, according to an embodiment of the present invention;

FIG. 35 illustrates a schematic representation of a screenshot of the user interface, according to an embodiment of the present invention;

FIG. 36 illustrates a flowchart of a method executed by the client, according to an embodiment of the present invention;

FIG. 37 illustrates a flowchart of a method executed by the provider, according to an embodiment of the present invention; and

FIG. 38 illustrates a flowchart of a method for determining availability of a provider, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

As used herein, relational terms, such as “first” and “second” and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

In general, the invention described herein relates to a cross platform hybrid software application that may be implemented with any existing operating system known in the arts. User's of the system may include any number of clients, providers, and administrators. Each user is able to send and receive information throughout the network utilizing any electronic computing device including a personal electronic device (“PED”), computer, laptop, tablet, PDA, or similar implement.

The document sharing system permits a complete office sharing experience between the client and the service provider. The system can be utilized in almost any client-provider relationship whether the operations are of a business-to-business nature or consumer-to-business. Common utilizations may include law firm interactions, insurance agency interactions, or government interactions as well as many where high volumes of document exchange and conferences are commonplace. For simplicity, the term user, when utilized, may refer to any client, provider, or administrator or combinations thereof.

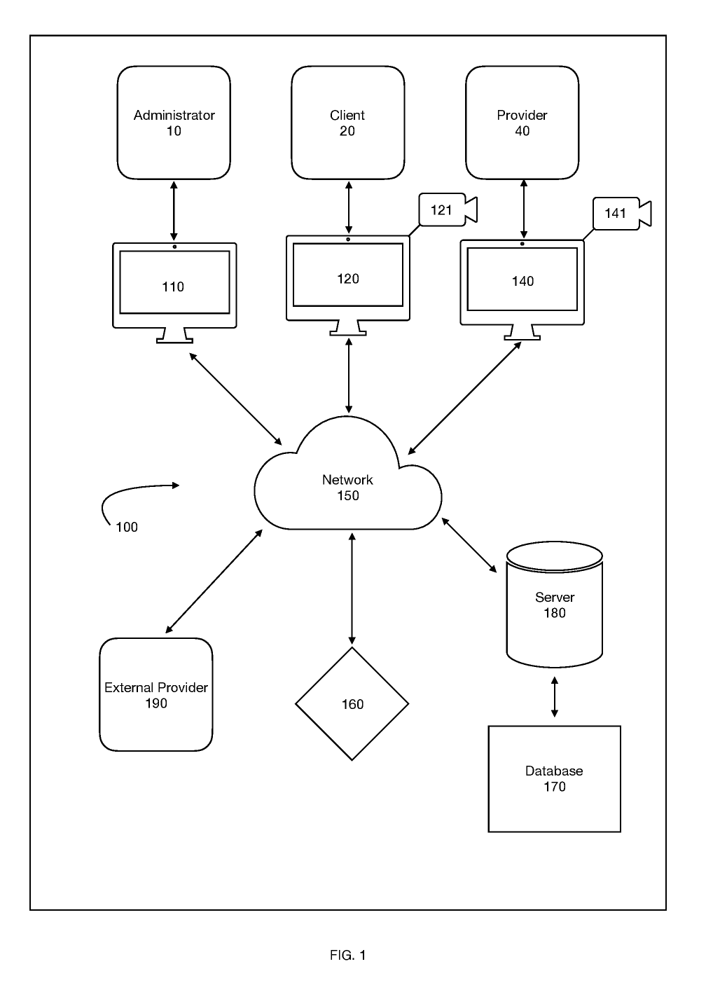

In reference to FIG. 1, a schematic of the system 100 configuration from the network 150 perspective is illustrated in an embodiment of the present invention. At least one client 20 utilized a client-associated device 120 to wirelessly communicate with the network 150. Further, a provider 140 is in wireless communication with the network 150 using a provider-associated device 140. While wired configurations are certainly possible, the invention could perhaps be most well-suited for convenience with a wireless network. The wireless configuration limits the requirement of a face-to-face interaction between the client 20 and provider 40. In lieu, the client 20 and provider 40 may be remote from one another. To facilitate the interaction, each device 120, 140 may be in wired or wireless communication with a camera and microphone, or similar audio/video capturing means 121, 141.

In an embodiment, an administrator 10 may also be in wireless communication with the system using an administrator-associated device 110. As known in the arts, various network protocols may be utilized such that each device 110, 120, and 140 is in communication with one another over the network 150.

It can be appreciated by one skilled in the arts that each of the client-associated device 110, provider-associated device 140, and administrator-associated device 110 may include any combination of network-communicable devices known as listed above including cell phones, tablets, computers, laptops, and similar implements.

In an embodiment, a server 180 may be in communication with a database 170 configured to transmit and receive data to be stored therein.

It can be understood that any number of external providers 190 may be utilized to efficiently execute the function of the provider-client relationship. For example, this may include cloud storage services, external data services, payment fulfillment services, invoicing and accounting platforms, among any other service known in the arts of each provider 40 and client 20.

Further, each user 10, 20, 40 may utilize an external device 160 to execute any number of tasks. As an example, the external device may include a document scanner to upload files to the network for utilization by any combination of users.

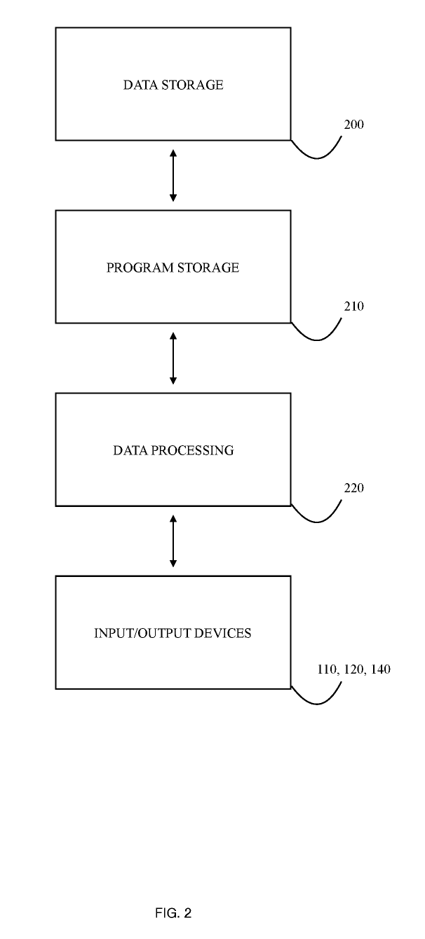

In specific reference to FIG. 2, a flowchart of information across the network is illustrated in an embodiment of the present invention. Block 200 represents data storage module in communication with the program storage module 210. Data may be processed by any number of processors on each device 110, 120, 140. Each processor instructs a plurality of modules on each device to perform the necessary functions of the system 100.

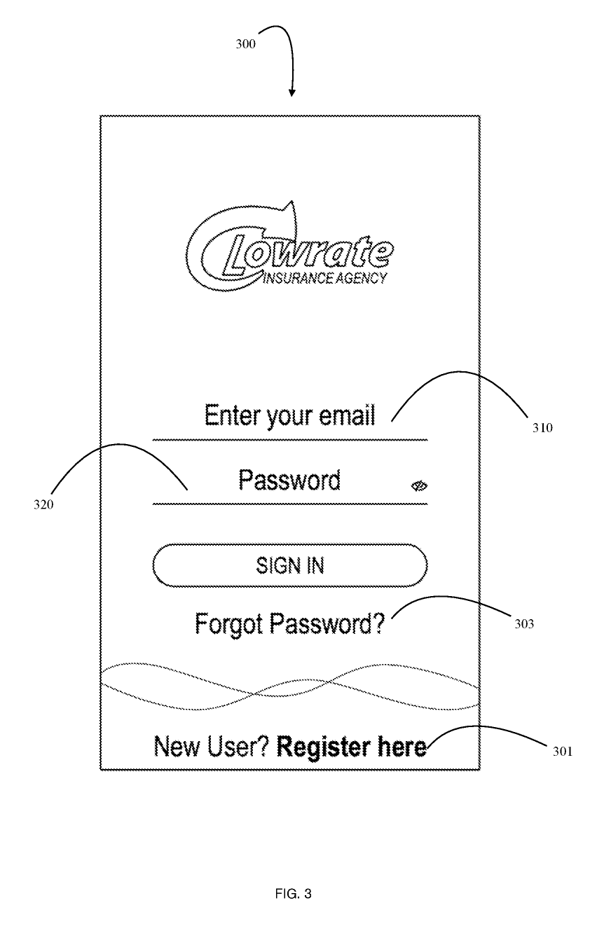

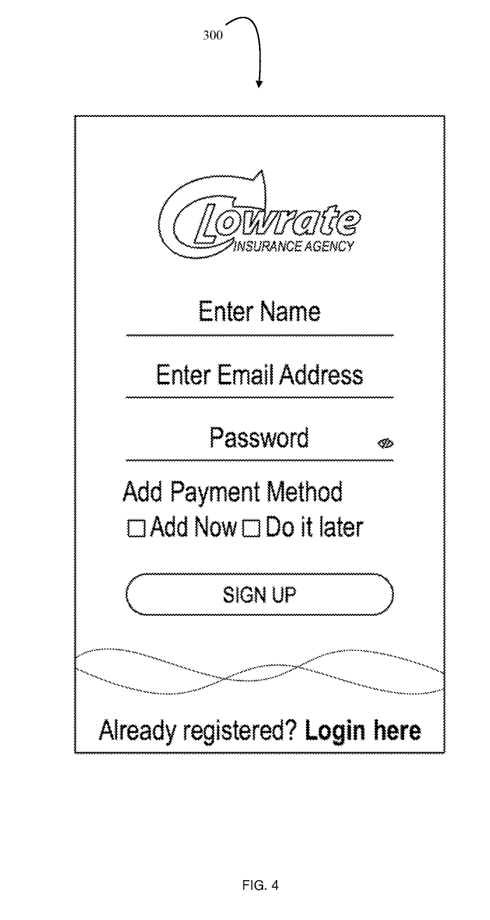

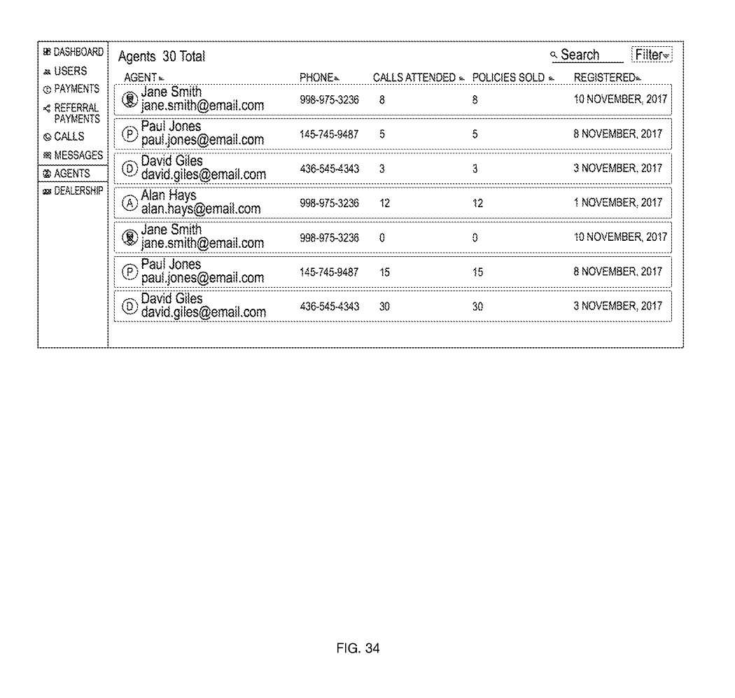

FIGS. 3-35 illustrate various embodiments of a graphical user interface (“GUI”) 300 in various embodiments of the present invention. It can be understood that while the specific GUI relates to an insurance provider, many other professional services may utilize the instant invention as described herein. Specifically referencing FIGS. 3 and 4 illustrate a user sign-in page commonly utilized in the arts. New users may be directed to a registration module 301 (illustrated in FIG. 4) while existing users may log-in with pre existing credentials into input fields 310, 320. Credentials may include those known in the arts including email, password, username, and standard security functionalities. In the instance the user forgets valid credentials, a credential recovery module 303 may be followed as known in the arts.

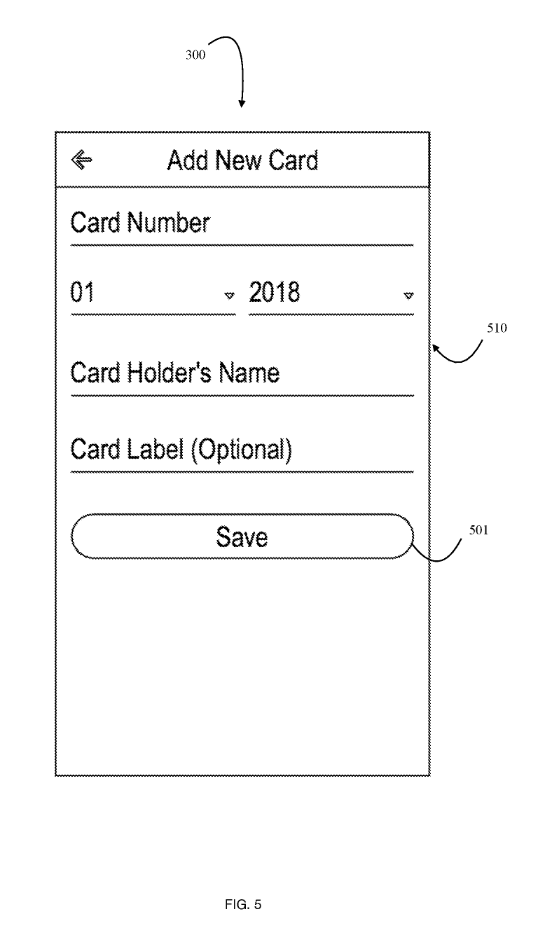

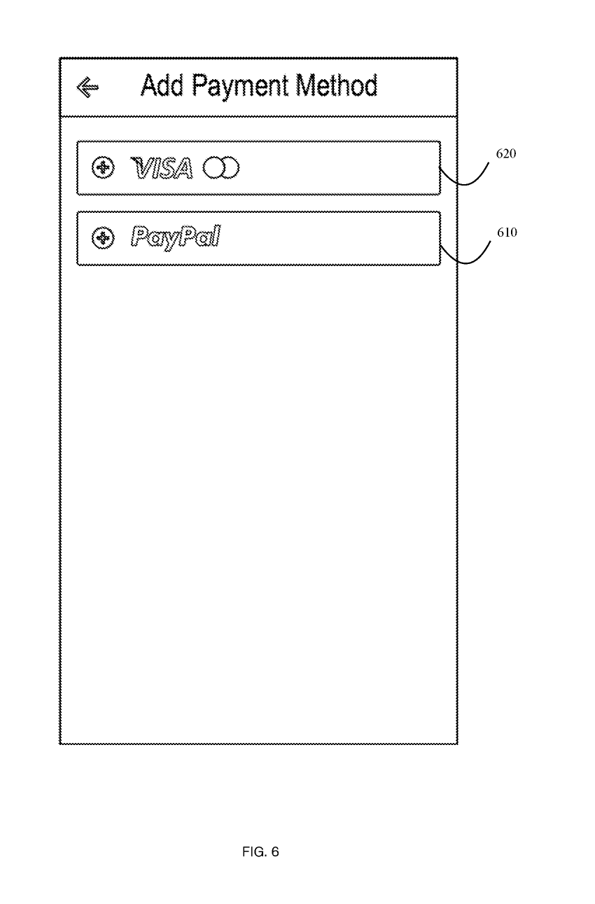

In an embodiment and in reference to FIGS. 5 and 6, the client 20 may be directed to input payment credentials 510 using payment processing services known in the arts. In further embodiments, payment processing services may include banks, credit card providers 620, and online payment systems 610 such as Paypal. Selecting “SAVE” 501 exports payment credentials to database 170 wherein data may be recalled when requested by the provider 40. Any secure means of connection may be established to retain fidelity of the data within the network 150. It can be noted that payment may be required at any time throughout the process depending on the service requested or provider 40 preference.

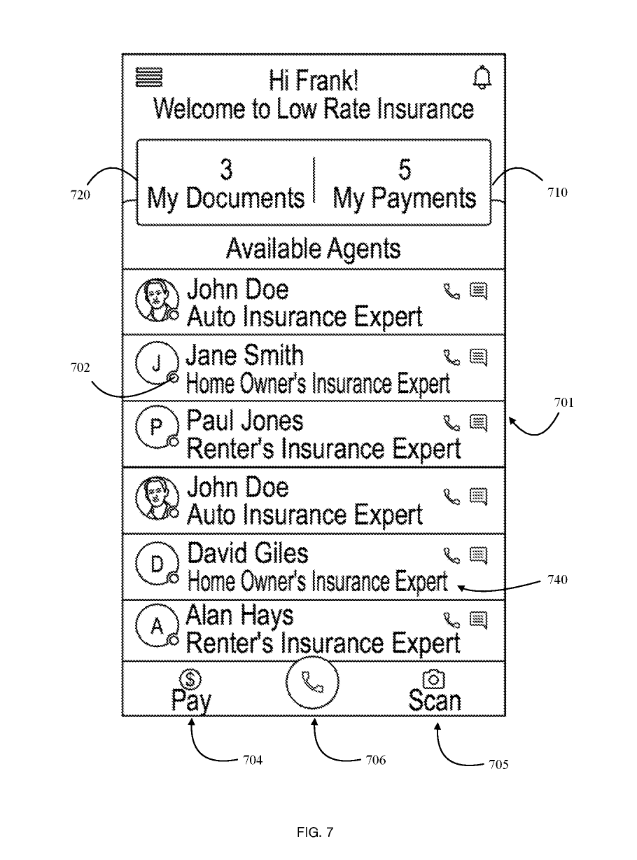

FIG. 7 illustrates a schematic following a successful client 20 login to the network 150. In an embodiment, a listing 701 of available providers 40 is generated. To generate the list of providers 40 the system may infer a plurality of indications as to the availability of the specific listed provider 40. For example, as the provider logs-in to the system, the availability may be indicated using an indicator 702. The indicator may be adjusted as a specific provider 40 is on another call, has a scheduled meeting, or has alerted the system that they are otherwise busy and unable to take a client 20 call. The user may select a “My Documents” button 720 to view previously engaged documents stored in the database 170. Further, the user has access to a payment history by selecting a “My Payments” button 710. Each provider 40 within the listing 710 is denoted with a service description 740 alerting the client 20 to a specific specialty of the provider 40. In the present embodiment, the client 20 is given a variety of insurance providers.

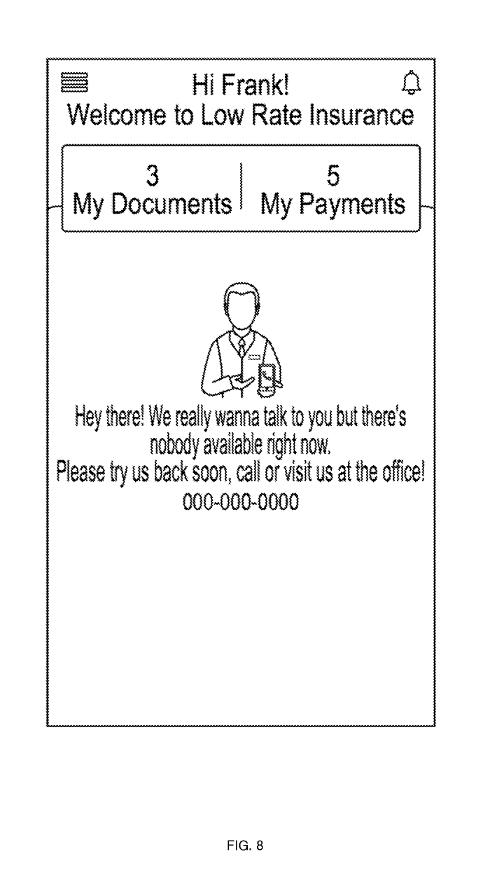

If a client 20 selects an unavailable provider 40, the screen of the GUI 300 illustrated in FIG. 8 is generated alerting the user that the indicated provider is not available. This screen may also be generated if no providers are currently available from the listing 701.

Referring back to FIG. 7, the user may select an available provider 40 from the listing 710 and then elect to perform a variety of communicable actions to the provider 40. For example, the client 20 may elect to pay the provider by selecting the “Pay” button 704. The client 20 may also contact the provider 40 utilizing a “Call” feature 706 wherein a call module is utilized to contact the provider 40.

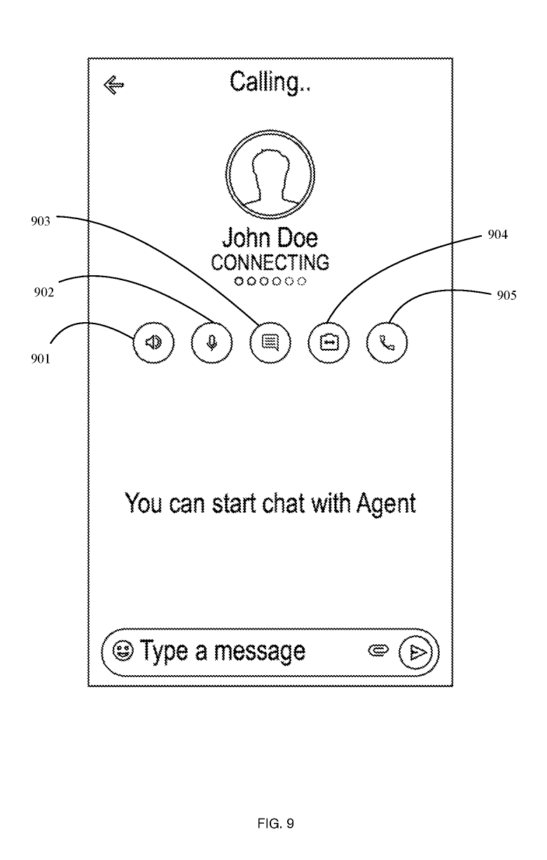

As known in the arts, a processor instructs the device to utilize the phone module of the specific device. One skilled in the arts may appreciate that a cloud-based calling service may also be utilized. As the user engages in a call, FIG. 9 illustrates the GUI 300 during the connection process. The user may be provided with a variety of features including speaker and volume preferences 901, 902, type messaging features 903, document sharing features 904, and phone features 805. Each corresponds to a processor instructing the device to perform functions known in the arts of user to user communications.

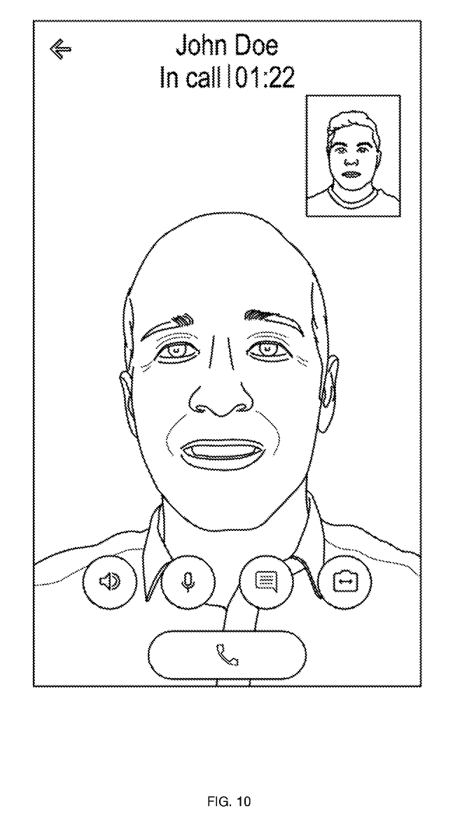

Once connected with the provider 40 the user may elect to Call the provider wherein a video feed 1000 may be utilized as illustrated in FIG. 10. This substitutes as a means for face-to-face interactions between the provider 40 and client 20. Meanwhile, the user maintains the ability to preferences and features 901, 902, 903, 904, 905 during the communication.

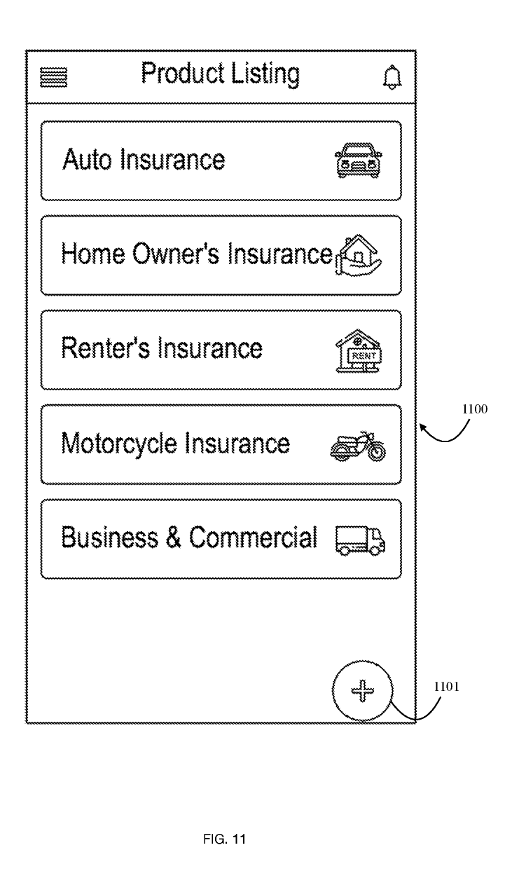

Now referring to FIG. 11, a service listing 1100 may be generated to provide the user with a list of services. These services may correspond with service descriptions 740 illustrated in the provider listing 701 (see FIG. 7). In the instant embodiment, a plurality of insurance services are illustrated. This may alter based on the professional provider requested by the client 20. The service listing 1100 may be modulated by the user such that the user may add or remove items from the listing 1100. This may include the option to “Add” services by selecting the “Add” button 1101.

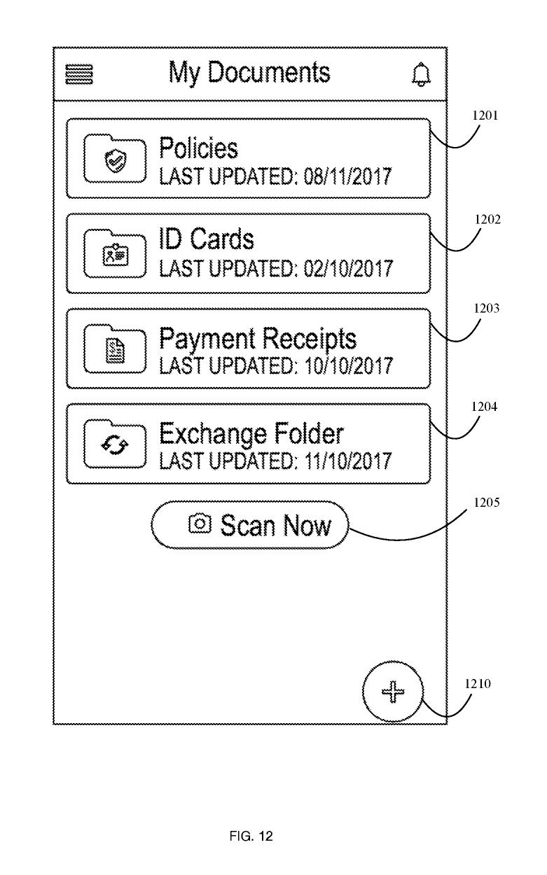

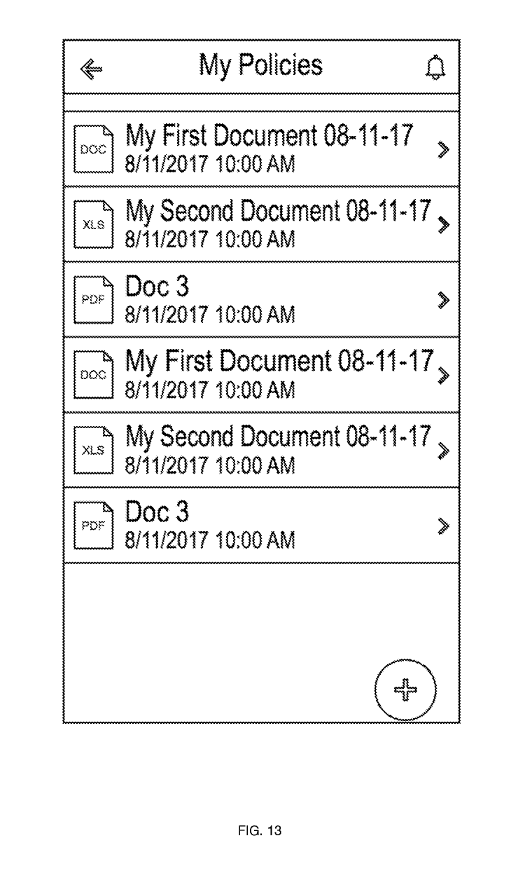

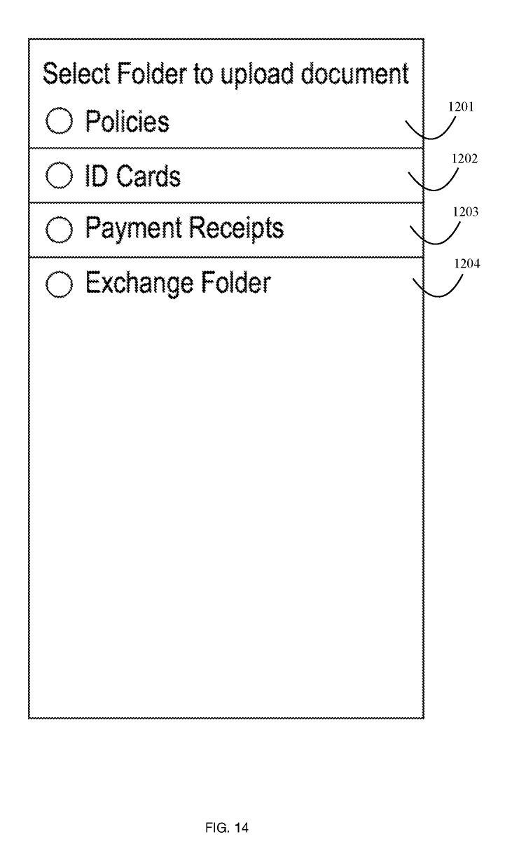

FIG. 12 illustrates a generated GUI 300 once the client selects the “My Documents” portal 720 (refer to FIG. 7) wherein a plurality of selectable folders are present. This may include a “Policy” folder 1201, “ID Card” folder 1202. “Payment Receipts” folder 1203, and “Exchange” folder 1204. Additional folders may be added as required utilizing implement 1210. FIG. 13 illustrates an embodiment of the GUI 300 illustrating a plurality of stored documents 1301 to the “My Policies” folder which may be stored in the database 170. New documents may be uploaded by selecting a document upload feature 1303. As a user elects the document upload feature 1303, the user is prompted to select the specific folder 1201, 1202, 1203, 1204 wherein the document is to be stored (see FIG. 14).

Any means of uploading a document may be utilized. In a specific embodiment, an external device 160 may be implemented such as a scanner. To perform the functions necessary, a “Scan Now” feature 1205 may be elected such that a processor instructs a scanner to upload a scanned document to be stored in the database 170 in communication with the network 150.

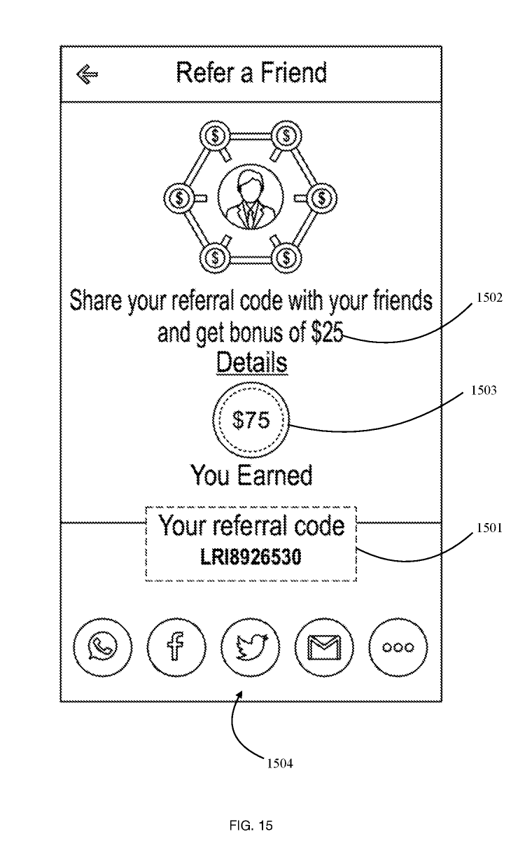

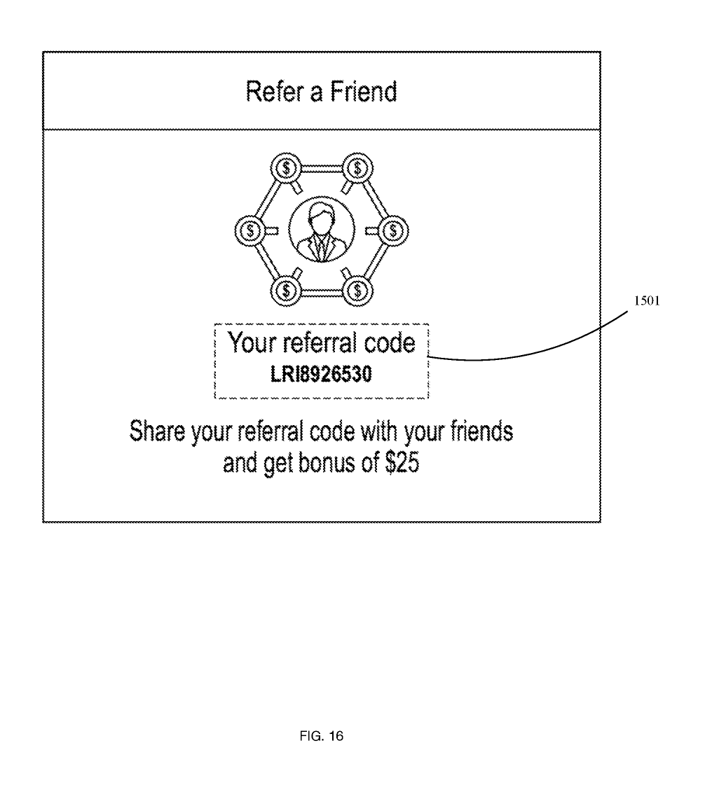

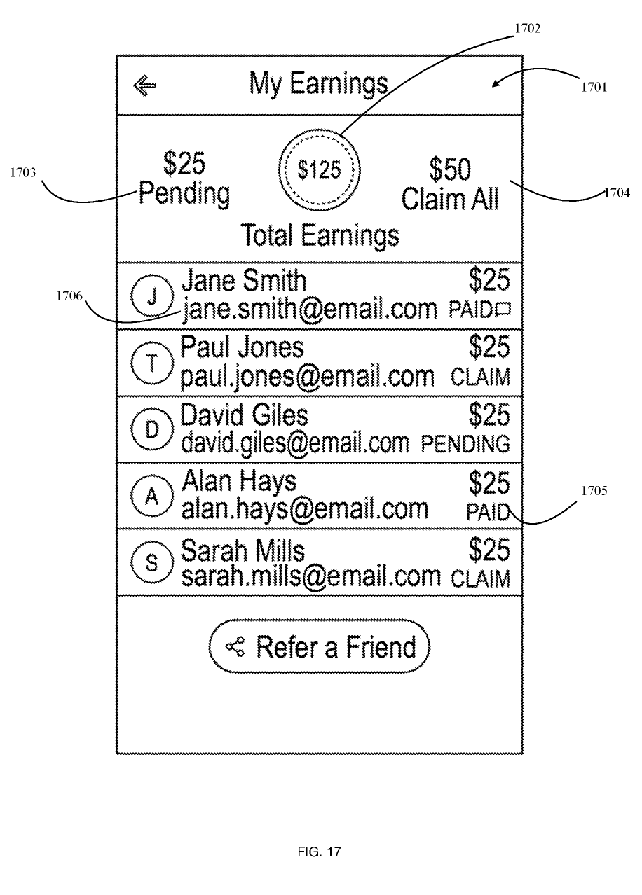

In an embodiment and in reference to FIGS. 15 and 16, to promote the utilization of the system 100, a referral program may be utilized wherein clients 20 may refer the system 100 and its functionalities to other external potential clients. To execute, a referral code 1501 may be generated corresponding to an award value 1502 to be transmitted to the client whom is associated with the referral code. A total earned reward value 1503 may also be viewed by the user. The referral code 1501 may be sent by the client 20 to a specific user via messaging, email or similar implement. Likewise, social media networks 1504 may be utilized to transmit the referral code to non-specific prospective users. In this manner, various external media platforms may be in communication with the system 100 as known in the arts. In an embodiment and referring to FIG. 17, a “My Earnings” 1701 screen may list previously executed referral codes resulting in the reception of funds. A running total of earnings 1702, pending total 1703, and available funds 1704 functionalities may be presented. Screen 1701 may indicate specific prospective users payment status 1705, contact credentials 1706, among other details known in the arts.

In an embodiments, earnings 1701 may be utilized as credits redeemable as a payment option for the client 20. This would allow for the client 20 to utilize credits as a means of paying a payment request sent by a provider 40.

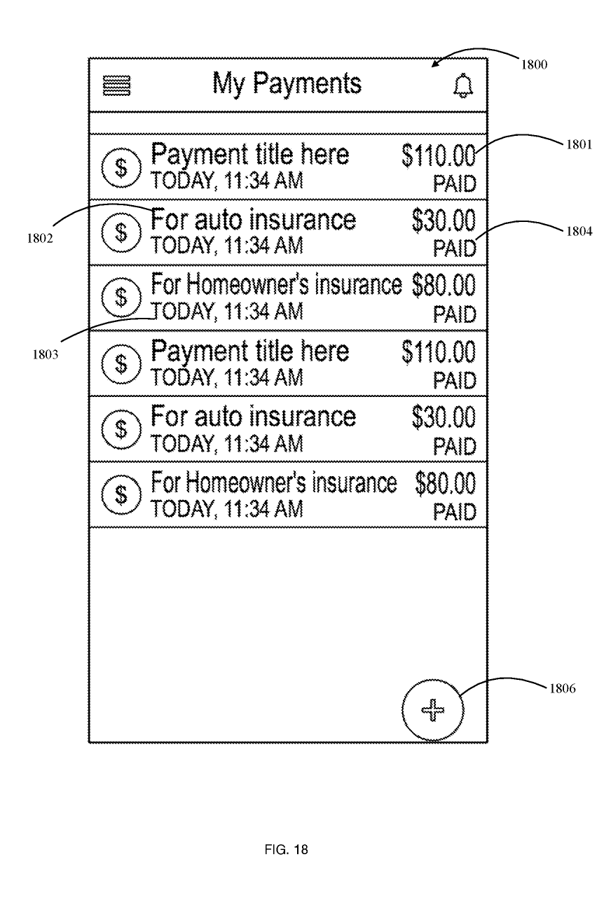

FIG. 18 illustrates a payments listing 1800 wherein each payment amount 1801, service 1802, date of the payment 1803, and payment status 1804 are organized on the GUI 300. Payments may be added manually 1806 by the user or automatically by a processor instructing a payment processing module.

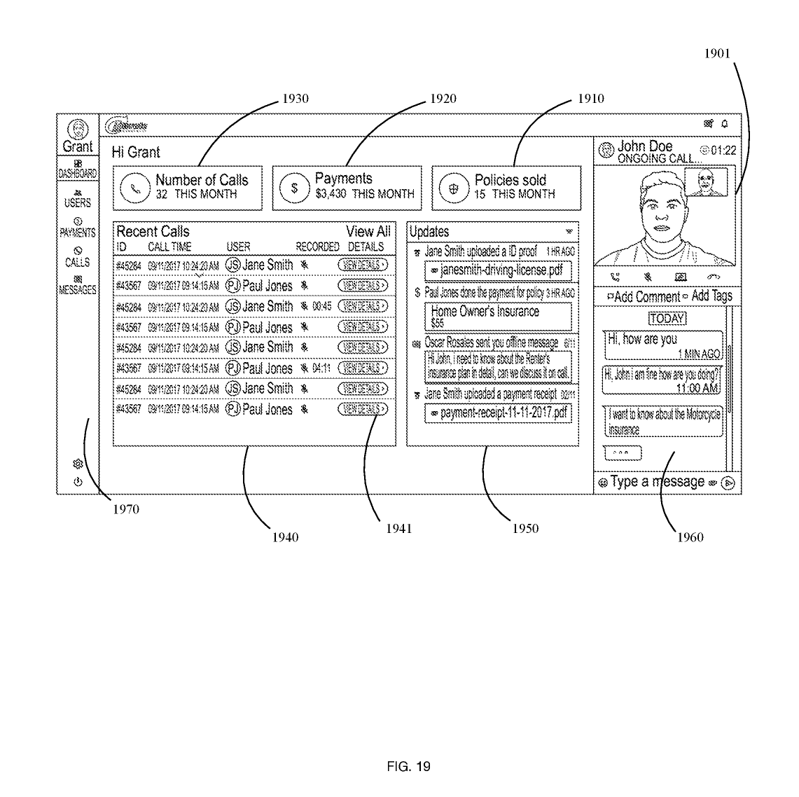

The invention described herein relates not only to the interface for the client 20, but also for the provider 40 GUI and its functionalities. Embodiments of the provider GUI are illustrated in FIGS. 19-25 and described herein. Once a provider 40 has registered with the system 100, a provider-associated GUI 1900 may be present on the provider-associated device 140. During a call, the call interface 1901 may be present showing a video feed of the client 20 among other features similar to FIG. 10 which shows the process from the clients 20 perspective. Further, a messaging interface 1960 permits the user to type a message in addition to a voice transference. Meanwhile, the provider may access an update interface 1950, recent call interface 1940, and further metrics interfaces 1910, 1920, 1930 as needed. Actions bar 1970 may provide for further functionalities of the system 100 which the provider may access from interface 1900.

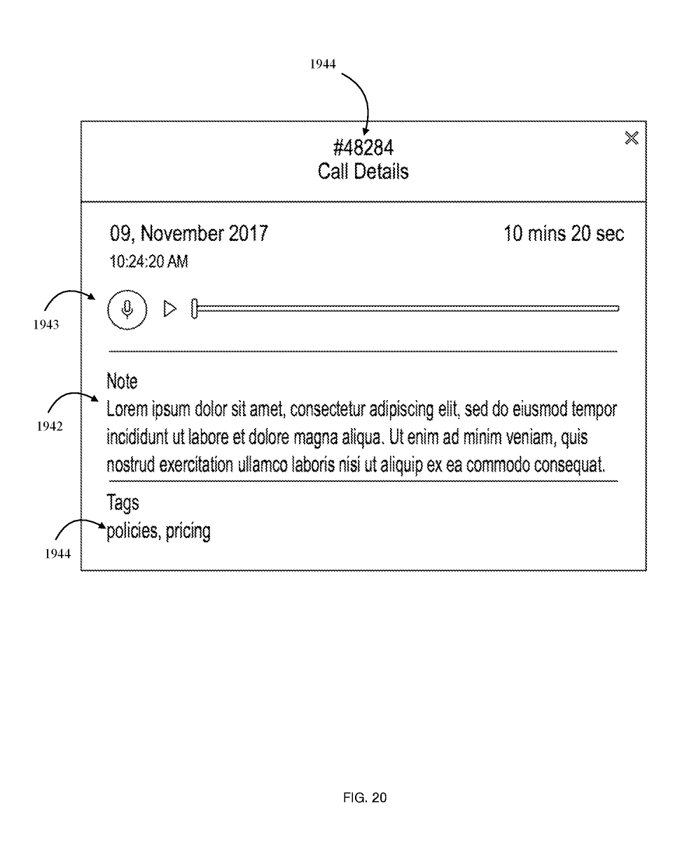

Within the recent call interface 1941 the provider 40 may select to “View Details” of the call such that the interface in FIG. 20 is presented. This results in notes 1942 from the call being accessed from database 170 as well as an audio or audio/video recording 1943 related to the indicated call. Calls may be referenced by a call identifier 1944 such as a numeric or alphanumeric identifier as shown. The call identifier may recall data by associated a call identifier with a stored data, then transmitting the indicated data to the provider GUI. A tag 1944 may allow the provider to place an inquire for a specific key term (Tag 1944) and list relevant files.

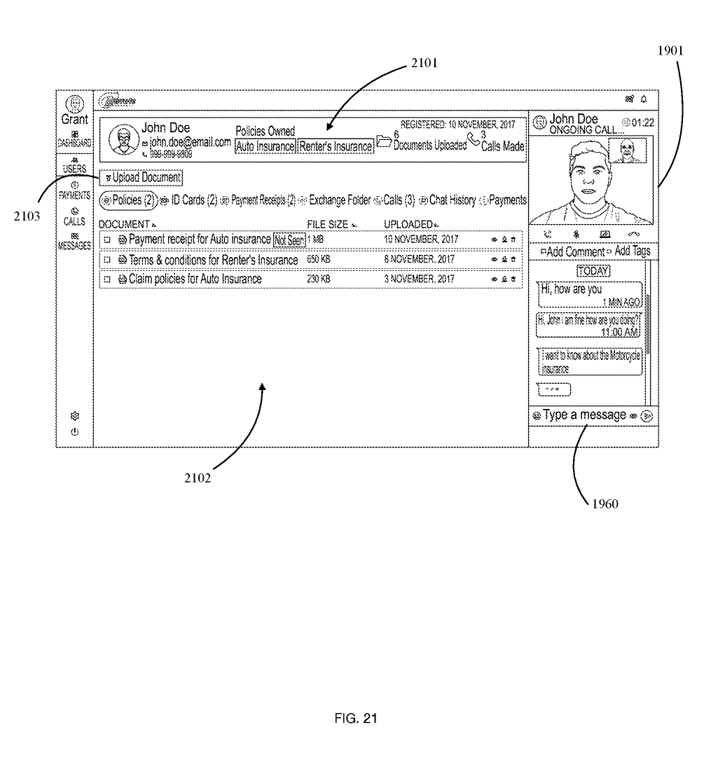

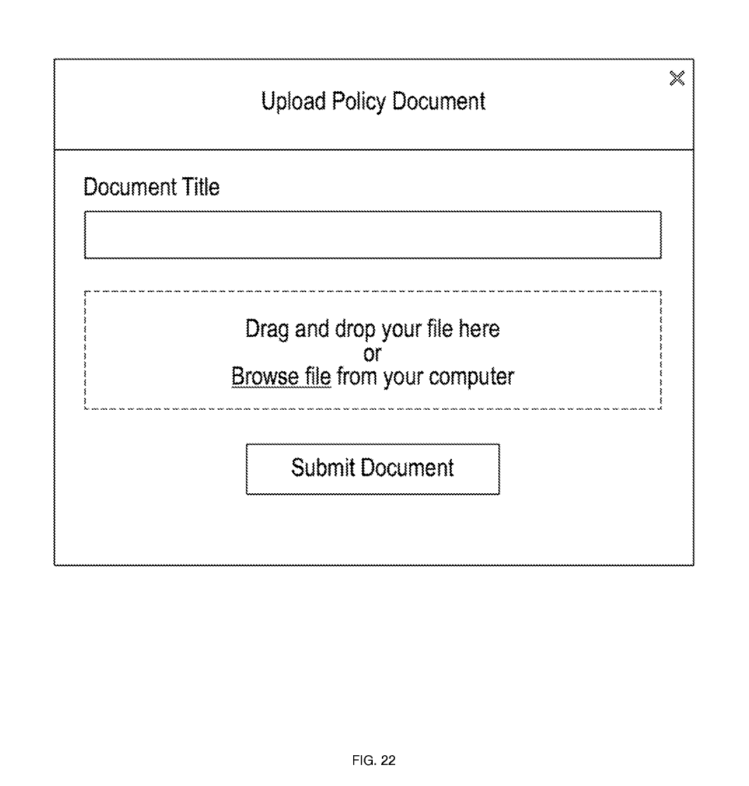

In an embodiment, electing a specific client 20 permits the provider 40 to access client details interface 2101 having interaction details including previous files, specific policies owned, past calls, among other features illustrated in historical client interface 2102 as illustrated in FIG. 21. This screen may be accessed concurrently to communications with the client such that the call interface 1901 and messaging interface 1960 may still be engaged with. The provider may further upload documents using the “Upload Document” feature 2103 provided. This results the module illustrated in FIG. 22 permitting the provider to upload and submit a document stored locally or remotely. A drag-and-drop module may also be provided for convenience.

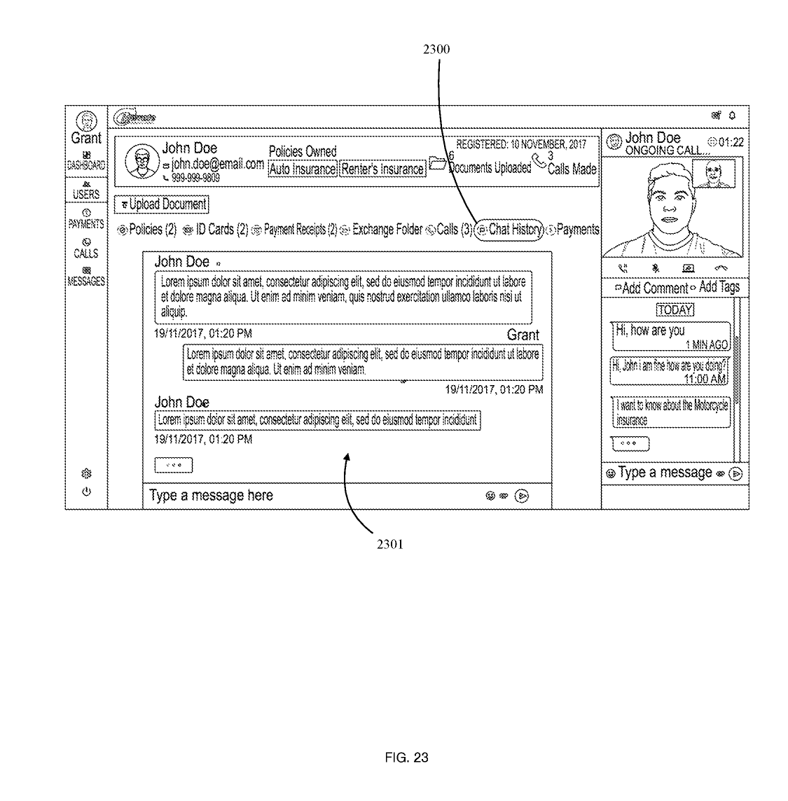

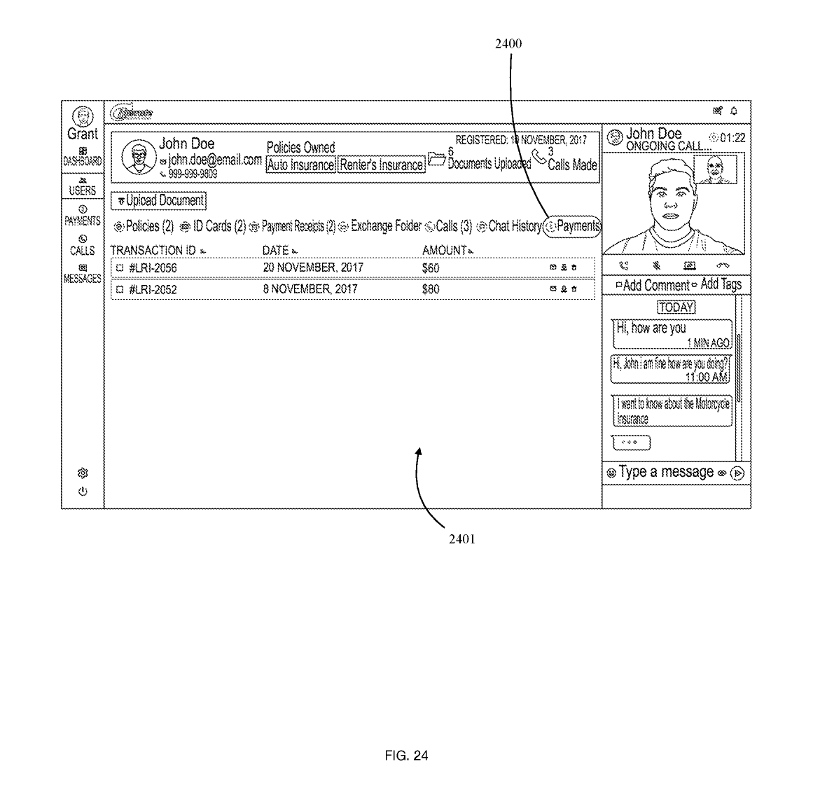

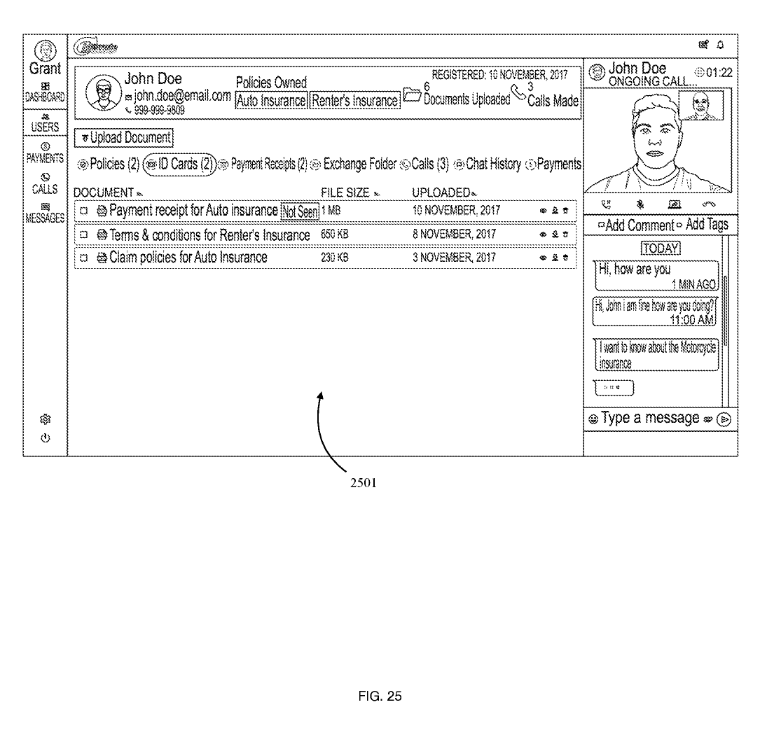

FIG. 23 illustrates a “Chat History” 2400 related to the specific client permitting the provider to view stored messages generated via messaging interface 1960. The chat history 2301 is displayed as the provider 40 selects the “Chat History” function 2300 FIG. 24 specifically relates to a payment history listing 2400 illustrated once a “Payments” functionality 2401 is selected. FIG. 25 similarly shows a previous document listing 2501 related to the specific client. As shown in each of FIGS. 23-25 the provider may select from a variety of functionalities including “Policies”, “ID Cards”, “Payment Receipts”, “Exchange Folders”, “Calls”, “Chat History”, and “Payments”. Each functionality may be modulated depending on the service provided. For example, an insurance provider may not require the same functionalities as a law firm or government service (e.g. Department of Motor Vehicles).

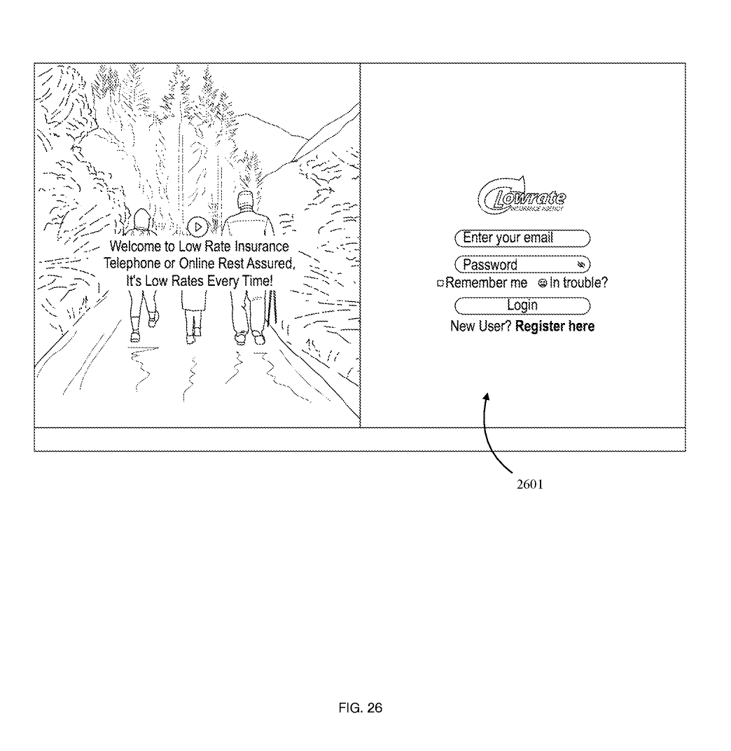

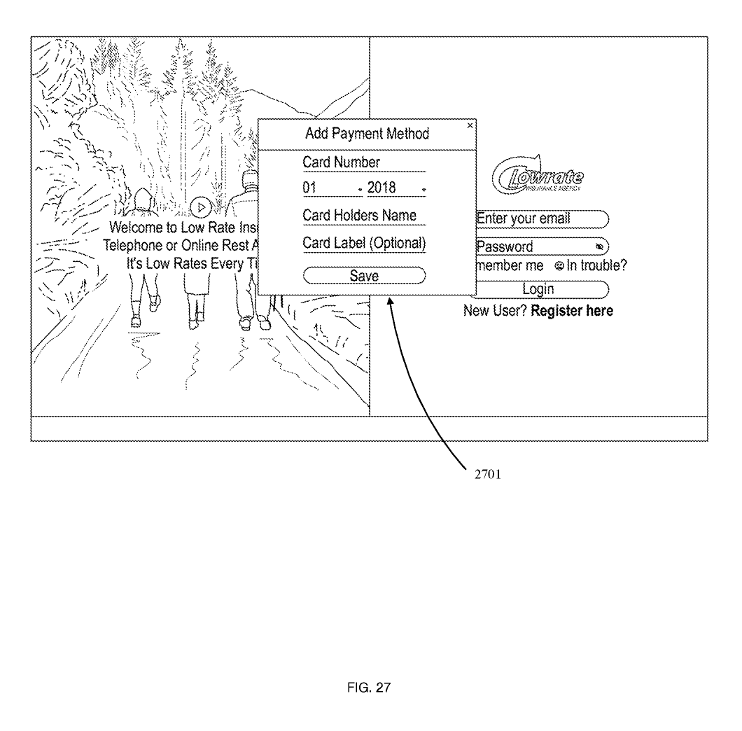

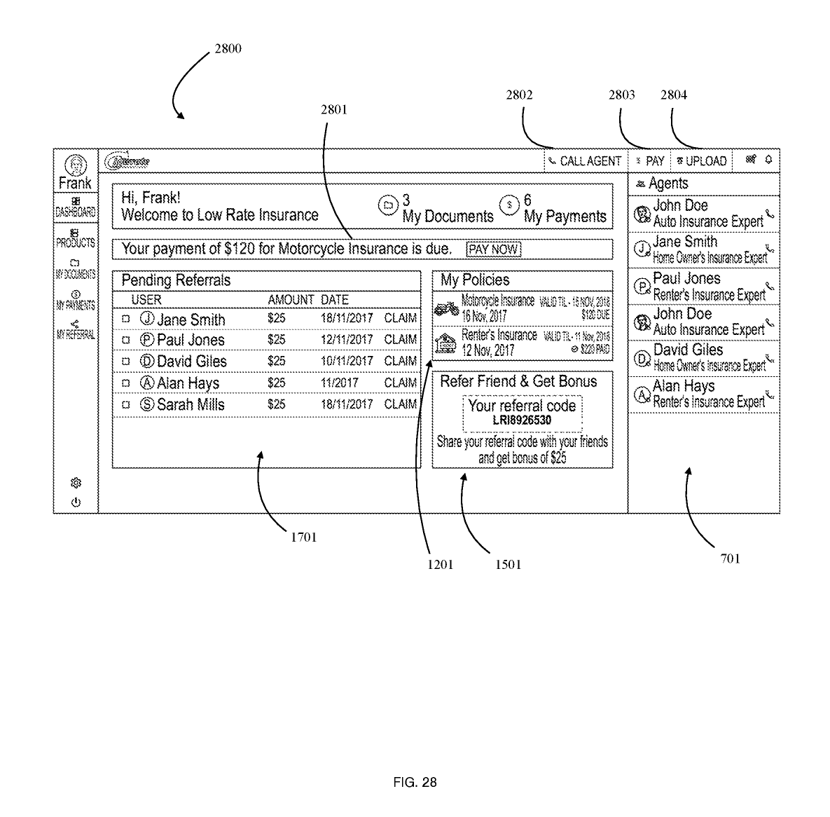

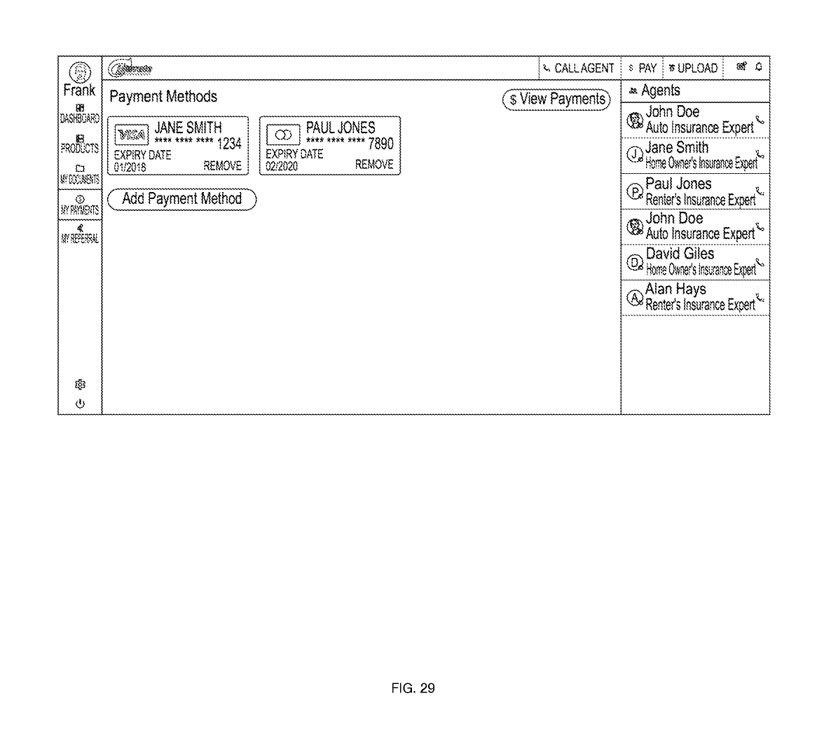

FIGS. 27-32 illustrate another embodiment of the client-associated GUI from the client perspective when the client device 120 is a computer or similar non-handheld implement. It is a goal of the present invention to provide similar functionalities across a plurality of devices, whether handheld or desktop. The system may determine the device type the client 20 is currently using as known in the arts, such as the utilization of an adaptive transmission controller. Similar to FIGS. 3 and 4. FIGS. 26-27 illustrate a home screen wherein the client 20 may register or login the pre existing credentials using input fields 2601 as well as add payment credentials at 2701. Existing payment methods input by the client 20 may be accessed as illustrated in FIG. 29. Once the user has a successfully login, the client 20 is presented the client-associated home screen 2800 as illustrated in FIG. 28. The client 20 is provided with an available agents listing 701 providing the user with currently available providers 40 or previous providers 40 whom they have worked with previously as well as an indicator related to their availability. The client may be provided with an upcoming bill notification 2801 as well as the option to pay the bill. In alternative embodiments, the user may implement a variety of user settings permitting automatic billing among other payment plans. Further functionalities may include the option to “Call Agent” 2802, “Pay” 2803, “Upload” 2804 as described above as well as other functions commonly associated with the arts. As illustrated in previous embodiments, pending referrals 1701, policies 1201, and referral codes 1501 may be presented to the user in the computer GUI.

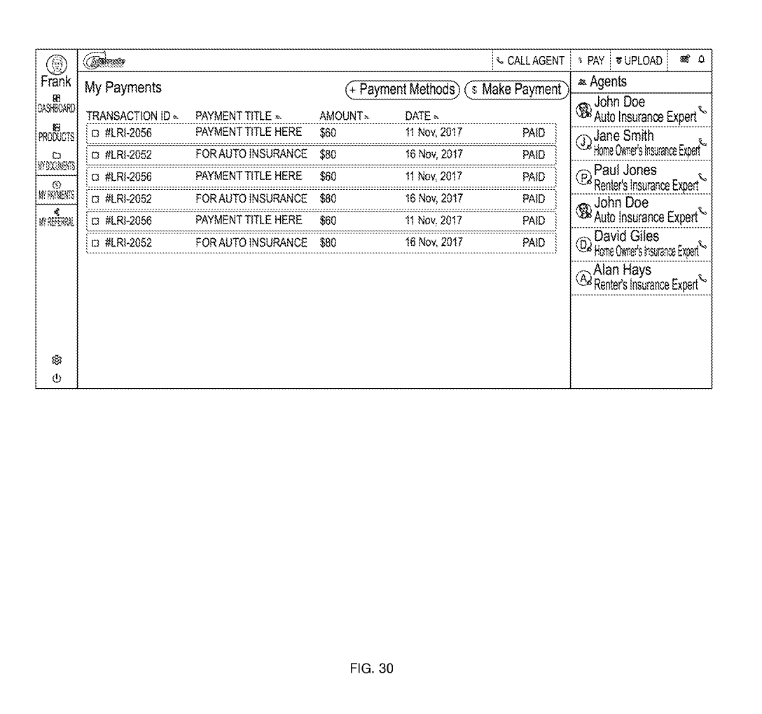

Referring now to FIG. 30, the client 20 may access a previous payment listing 3000 having a transaction ID, as well as other identifiers noting the execution of historical payments within the system.

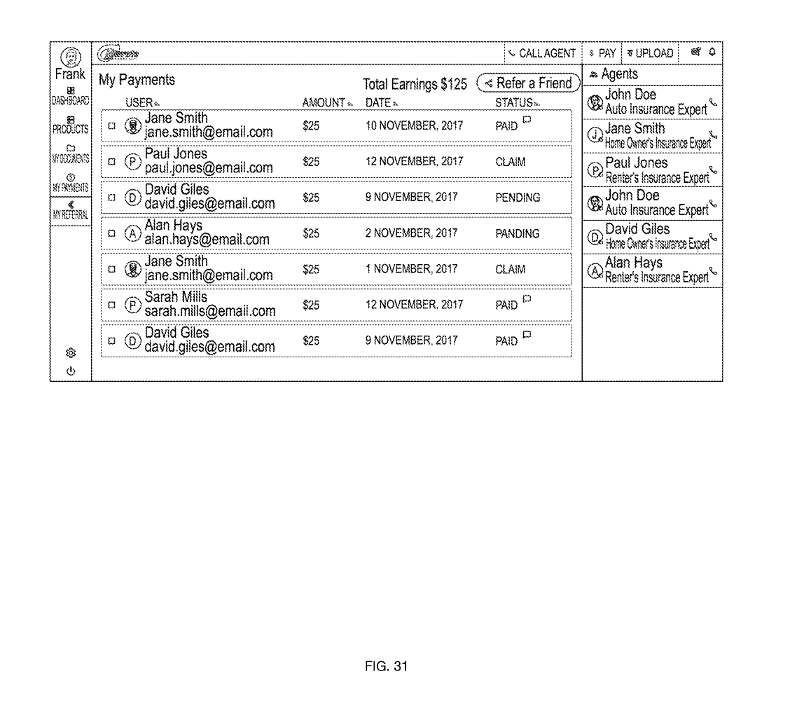

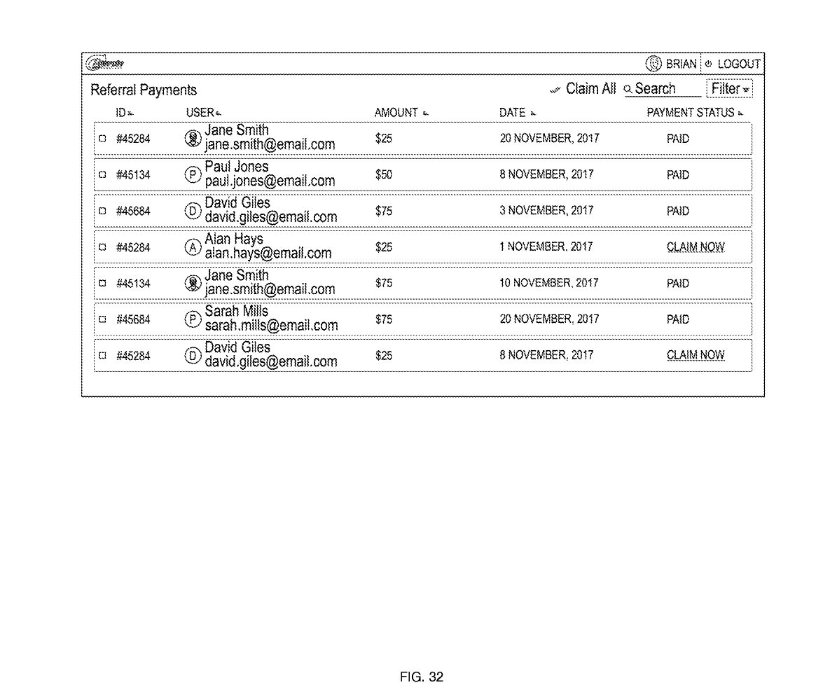

FIGS. 31 and 32 illustrates pending referrals and their payment status as described above an illustrated in an alternate embodiment in FIG. 17.

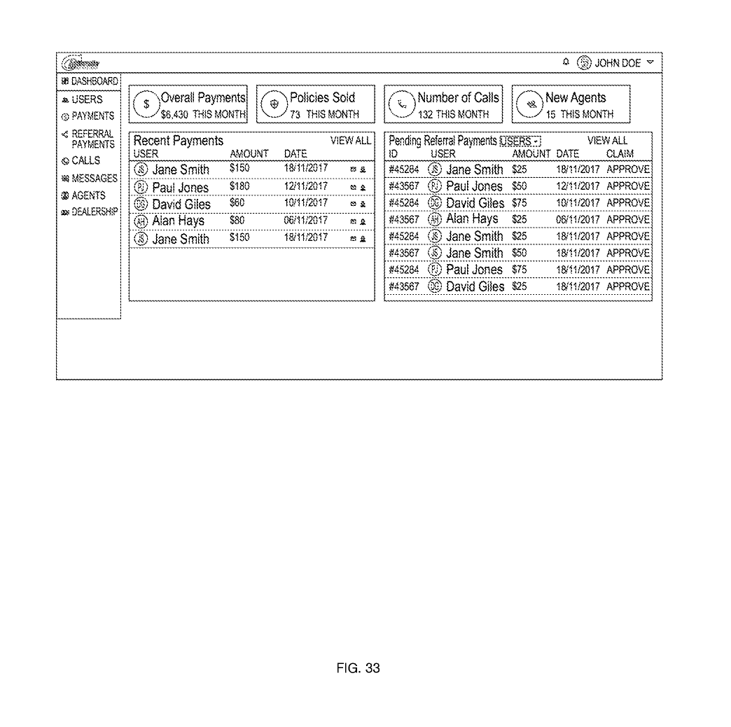

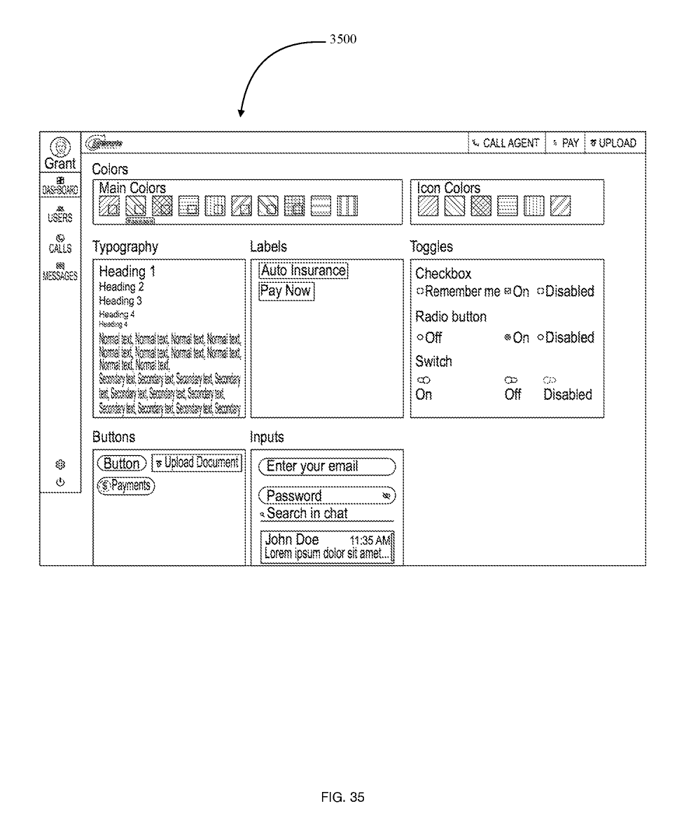

FIGS. 33-35 illustrate the GUI from an administrative perspective permitting an administrator 10 to view any metric utilized in the system 100. This may include but is not limited to provider and client metrics including contact information. FIG. 35 specifically illustrates system settings 3500 including a variety of GUI settings known in the arts.

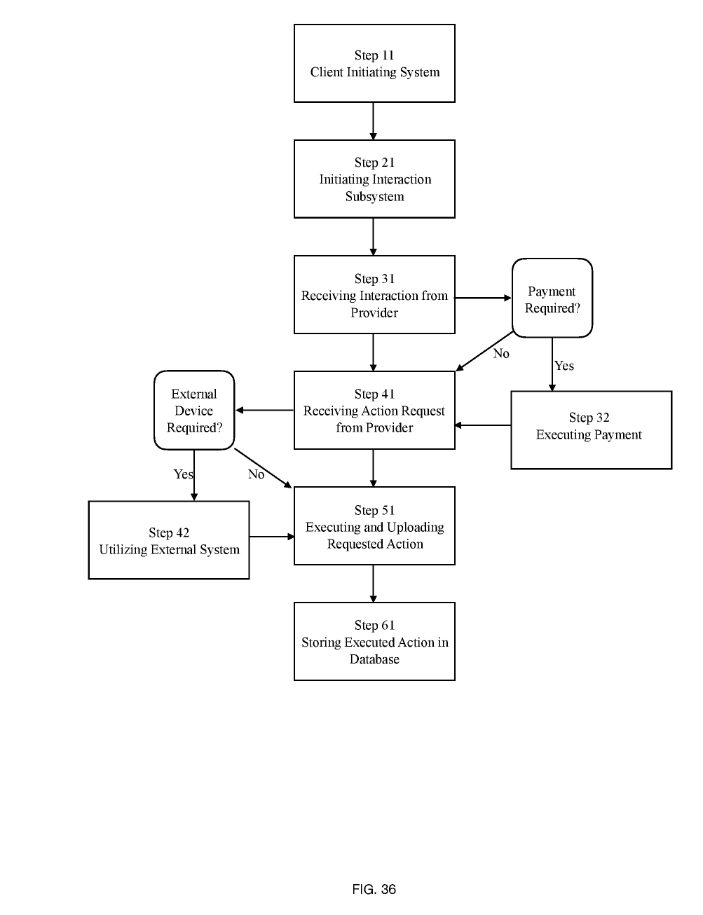

It is the intention of the present invention to place a client 20 and provider 40 in remote wireless communication with one another over the network 150 as described above. A process for achieving this is illustrated in FIG. 36 according to one embodiment of the present invention. It may be noted that a number of steps may be re-ordered, or may be performed concurrently. Step 11 requires the client to initiate the system. This may include booting the device and software necessary within the device. In step 21, the interaction subsystem is initiated such that the client may interact with one or more providers currently available. In step 31, the client receives an interaction from the provider. If a payment is required, the user may perform optional step 32 by executing a payment. Once an action request is received by the client from the provider in step 41, the user may be required to utilize an external system in step 42 in order to execute and upload the action in step 51. In step 61, the executed action may be stored in the database.

In a specific example, an interaction between a client and provider has been established, the provider may require a previously unexecuted document to be signed by the client. Once the document is received by the client, they may utilize an external system such as a scanner, or even a cloud-based service such as DocuSign to appropriately execute the document. At any point during the interaction, the provider may request or require payment to be fulfilled for the rendered service or action to be completed.

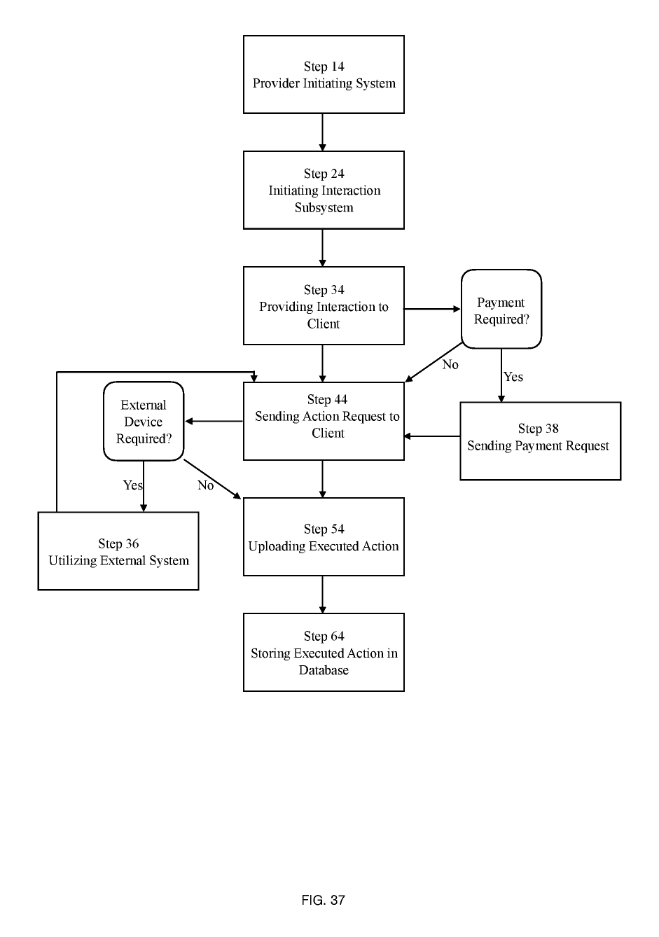

In correspondence with FIG. 36, FIG. 37 likewise illustrates a process from the perspective of the provider throughout an interaction. The provider initiates the system and interaction subsystems in steps 14 and 24. Once an interaction is provided in step 34, an action may be requested in step 44. This may then be uploaded for future recollection in steps 54 and 64 for future interactions and record keeping purposes. If a payment is requested or required, optional step 38 permits the request to be sent.

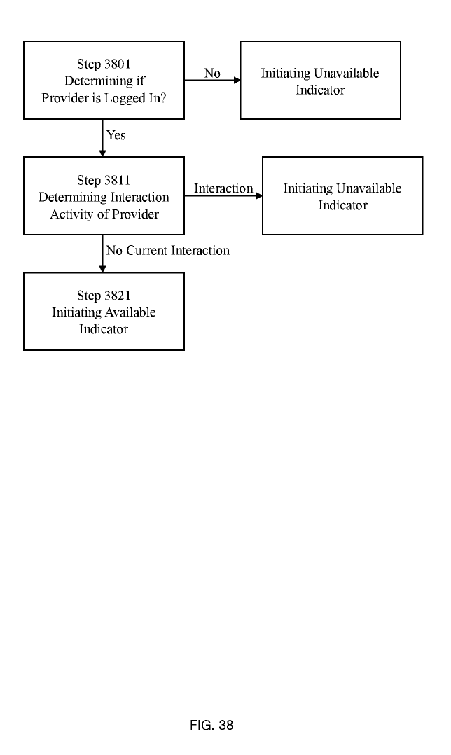

As illustrated in FIGS. 7 and 28, the ability of the system to convey availability of the providers 40 in real-time is essential to the convenience of the present invention. As mentioned above, indicators 702 may change dependent upon the providers 40 current availability. A provider 40 being available for an interaction may be communicated on the GUI by a green circle, while an unavailable provider may be communicated by a red circle. Of course, any combination and style of identifier may be used. Further, the client 20 should be given an indication for the service type that the provider is specialized in. For example, the client 20 may be seeking a provider for car insurance. They notice Provider 1 is available in whom specialize in car insurance, while another car insurance provider is busy with another call. To achieve this functionality, the process embodied in FIG. 38 may be utilized. In an example, and in step 3801, an availability module determines if a provider is logged into the system. If the provider is not logged in, the indicator will show as unavailable to the client. If the provider is in fact logged in, the availability module determines interaction activity of the provider in step 3811. If the provider is currently engaged in another interaction the indicator will likewise show as unavailable. If the provider is not engaged with an interaction, the indicator will be displayed as available in step 3821.

It can be appreciated that a multitude of means for determining whether or not a provider is available may be utilized. This may include predicting availability based on user preferences made by either the client 20 or provider 40. These may include location preferences, scheduled out-of-office times, breaks, or busy notices.

In yet another embodiment, the specific utilization of the system, such as for a government implement, may require additional security features to ensure the fidelity of the interaction. For example, a facial recognition module may be communicable with the client 20 and provider 40 devices. The facial recognition module is operable to communicate with any database facilitating the facial recognition process Once an identity has been validated with the user credentials.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for client and provider interactions comprising:
a network having a wireless communication interface configured to connect to client devices;
a client-associated device having a processor in communication with a user interface operable to perform the following;
determining provider availability;
executing a payment any one of the plurality of providers;
engaging in a provider-client interaction;
exchanging one or more actions with any one of the plurality of providers;
a provider-associated device having a processor in communication with a user interface operable to perform the following;
displaying previous client interactions;
engaging in a provider-client interaction;
uploading and sending a plurality of documents; and
requesting and receiving payments from any number of clients.

2. The system of claim 1, wherein an adaptive transmission controller processes content in multiple mobile versions optimized to screen sizes of the client devices.

3. The system of claim 1, wherein the one or more actions are electronic documents.

4. The system of claim 3, having an external device to affect the electronic documents.

5. The system of claim 4, wherein a scanner is utilized to execute the electronic documents.

6. The system of claim 1, wherein availability of the each of the plurality of providers is determined by the processor executing the following steps:
determining current login status of each of the plurality of providers to the user interface;
determining current interaction activity of the provider; and
initiating an available indicator.

7. The system of claim 1, having both video and audio means for engaging in an interaction.

8. A method of storing data related to a client to provider interaction comprising the following steps:
initiating, via the client, a document-integrated interaction system;
initiating, via the client, an interaction subsystem;
receiving interaction from at least one provider;
receiving at least one action request from the at least one provider;
executing the at least one action request;
uploading the executed action to the at least one provider; and
storing the executed action request in a database.

9. The method of claim 8, wherein an adaptive transmission controller processes content in multiple mobile versions optimized to screen sizes of the client devices.

10. The method of claim 8, wherein the one or more actions are electronic documents.

11. The method of claim 10, having an external device to affect the electronic document.

12. The method of claim 11, wherein a scanner is utilized to execute the electronic document.

13. The method of claim 8, having both video and audio means for engaging in an interaction.

14. A method of providing services to a remote client over a network comprising the steps of:
establishing an interaction between a client and at least one provider providing a service;
storing in a data format, remotely from the client, at least one of the following associated with the client;
at least one client credential;
at least one client-associated payment method;
permitting the client to select a service from the provider;
requesting payment from the client dependent upon the selected service;
directing at least one action from a provider device to a client device;
executing, by the client, the at least one action;
redirecting, by the client, the at least one executed action; and
storing, by the provider utilizing a database, the at least one executed action.

15. The method of claim 14, wherein an adaptive transmission controller processes content in multiple mobile versions optimized to screen sizes of the client devices.

16. The method of claim 14, wherein the one or more actions are electronic documents.

17. The method of claim 16, having an external device to affect the electronic document.

18. The method of claim 17, wherein a scanner is utilized to execute the electronic document.

19. The method of claim 14, having both video and audio means for engaging in an interaction.

20. The method of claim 14, wherein payments are collected utilizing a third party system.
